(19) United States
(12) Patent Application Publication
(10) Pub. No.: US 2010/0092531 A1
(43) Pub. Date: Apr. 15, 2010

(54) TEXTILE IMPLANT OF SHEATH-CORE CONSTRUCTION AND METHOD OF FORMING IT

(75) Inventors: Erich Odermatt, Schaffhausen (CH); Ingo Berndt, Tuttlingen (DE); Carlo Riccardo Centonze, Zuerich (CH); Murray Height, Zuerich (CH)

Correspondence Address: IP GROUP OF DLA PIPER LLP (US), ONE LIBERTY PLACE, 1650 MARKET ST, SUITE 4900, PHILADELPHIA, PA, 19103, US

(73) Assignees: AESCULAP AG, Tuttlingen/Donau (DE); HEIQ MATERIALS AG, Bad Zurzach (CH)

(21) Appl. No.: 12/577,246

(22) Filed: Oct. 12, 2009

(30) Foreign Application Priority Data
Oct. 13, 2008 (DE) 10 2008 052837.4

(51) Int. Cl. A01N 25/08; A01N 59/20; A01N 59/16; A01P 1/00

(52) U.S. Cl. 424/409; 424/630; 424/618; 424/649; 424/641; 424/617; 424/635; 264/103

(57) ABSTRACT

A textile implant includes at least one thread having a polymeric core and a polymeric sheath which surrounds the polymeric core at least partly, wherein the sheath includes a composition including at least one silica-supported antimicrobial active agent.

### RELATED APPLICATION

This application claims priority of German Patent Application No. 10 2008 052 837.4, filed Oct. 13, 2008, herein incorporated by reference.

### TECHNICAL FIELD

This disclosure relates to textile implants having sheath-core constructions, to tubular medical devices and also to manufacturing methods for the textile implants and the tubular medical devices.

### BACKGROUND

One of the challenges in modern surgical care is the surgical management of infected wounds and the avoidance of post-operative primary and secondary infections. Post-operative secondary infections are considered particularly problematic since they often only arise after several weeks or even months. This presents a particularly severe problem in the case of nonabsorbable implants in particular. In many cases, the implants have to be explained again that the infections can be dealt with successfully. Such surgical interventions are the cause of generally higher costs in the hospital sector, lead to longer hospital stays and represent additional stress for the patients concerned.

This is why surgical implants, for example, suture materials, hernia meshes, vascular prostheses but also knee and hip prostheses, are being increasingly endowed with suitable antimicrobial substances. An implant of this kind is described in DE 10 2004 047 568 A1, for example. One problem with antimicrobializing implants is generally that it is not rare for the antimicrobial substances to undergo an accumulated release into the surrounding biological tissue in the form of a brief and high-dosage “burst,” and this may engender inflammatory and in some instances even necrotic changes in the tissue.

A further disadvantage concerns particularly textile implants, for example, suture materials, vascular prostheses, hernia meshes and the like. There, the presence of antimicrobial substances, particularly when the substances are incorporated in the implant as particles and exceed a certain particle size, can cause mechanical weakening of the implants. This weakening can manifest itself particularly in reduced mechanical strength, for example, reduced linear breaking strength, knot breaking strength or flexural stiffness and, where appropriate, in a certain brittleness of the implant threads.

Finally, the addition of antimicrobial substances to polymer materials results in many cases in worse processibility of the materials, which makes the manufacture operation for such suture materials or textile implants costly and inconvenient.

Recently there have also been disclosed fiber products where the fiber material has inherent antimicrobial, particularly antibacterial, properties. Such bioactives are known from WO 02/081791 A2, for example.

It could therefore be helpful to provide an antimicrobialized textile implant without eliciting the known problems. It could also be helpful for an implant to combine sufficient mechanical strength for surgical uses with sufficient antimicrobial efficacy and be simple and, more particularly, inexpensive to manufacture.

### SUMMARY

We provide a textile implant including at least one thread having a polymeric core and a polymeric sheath which at least partly surrounds the polymeric core, wherein the polymeric core and/or the polymeric sheath include a composition including at least one silica-supported antimicrobial active agent.

We also provide a tubular medical device having an at least two-layered construction including an inner layer surrounding a tubular lumen and an outer layer surrounding the inner layer, wherein the inner layer and/or the outer layer include a composition including at least one silica-supported antimicrobial active agent.

We further provide a method of forming a textile implant including coextruding a molten thread core polymer and a molten sheathing polymer to form sheathed threads and subsequently processing the sheathed threads into a textile implant, wherein a composition including at least one silica-supported antimicrobial active agent is incorporated into the thread core polymer and/or into the sheathing polymer.

We still further provide a method of forming a tubular medical device including coextruding at least two polymer melts to form an at least two-layered tubular medical device having an inner layer surrounding a tubular lumen and an outer layer surrounding the inner layer and incorporating a composition including at least one silica-supported antimicrobial active agent into at least one of the polymer melts.

### DETAILED DESCRIPTION

It will be appreciated that the following description is intended to refer to specific examples of structure selected for illustration in the drawings and is not intended to define or limit the disclosure, other than in the appended claims.

The implant comprises a textile implant comprising at least one thread having a polymeric core and a polymeric sheath which surrounds the polymeric core at least partly, wherein the polymeric core and/or the polymeric sheath include a composition comprising at least one silica-supported antimicrobial active agent.

The textile implant has a sheath-core construction and an antimicrobial additive. The antimicrobial additive, as already mentioned, is based on a composition comprising at least one antimicrobial active and silica as a support material for the at least one active agent. The composition has a particular advantage of even in low concentrations ensuring a consistent and, more particularly, long-lasting delivery of the antimicrobial active agent. No accumulated, “burst effect” release of the active agent takes place, which distinctly reduces the risk of inflammatory or necrotic tissue changes.

The manner in which the polymeric sheath of the thread surrounds its polymeric core is generally complete and, more particularly, the entire area of the polymeric core is covered by the polymeric sheath. The sheath itself may have a construction featuring one, two, three or more layers. The proportion of the at least one thread which is attributable to the polymeric sheath is preferably between about 10% and about 60% by volume and particularly about 20% and about 50% by volume, based on the overall volume of the at least one thread.

Either only the polymeric core of the thread or only the polymeric sheath of the thread may include the composition. This spatial separation or compartmentization into antimicrobially active and antimicrobially inactive regions makes it possible to reduce the proportion of the composition, in particular, the proportion of the at least one antimicrobial active agent, in the at least one thread and hence the overall manufacturing costs for the implant. This is of special economic interest particularly with regard to pricey active agents, for example, silver. It must be particularly emphasized that reducing the antimicrobial additive to the polymeric core or sheath of the thread does not compromise adequate antimicrobial protection.

Preferably, it is only the polymeric sheath which includes the composition, that is, the polymeric core of the thread is free of the composition. This advantageously preserves the mechanical strength/resistance of the core of the thread. The implant can accordingly be used in surgery without reservation. Preferably, the composition is situated in the outermost layer of a polymeric sheath constructed in one, two, three or more layers. A further advantage of this structure is that the at least one antimicrobial active agent is present in surface-near regions of the at least one thread and, hence, in regions that are exposed to a particular risk of bacterial colonization.

Alternatively, it is only the polymeric core which includes the composition, that is, the polymeric sheath is free of the composition. Preferably, in this case, the polymeric core is formed of a nonabsorbable polymer material and the polymeric sheath of an absorbable polymer material.

The proportion of the polymeric core or of the polymeric sheath that is attributable to the composition is preferably between about 50 and about 100,000 ppm, particularly about 50 and about 40,000 ppm, more preferably about 500 and about 40,000 ppm, based on the overall weight of the polymeric core or of the polymeric sheath. The proportion of the polymeric core or of the polymeric sheath that is attributable to silica is between about 40 and about 95,000 ppm, particularly about 400 and about 38,000 ppm, based on the overall weight of the polymeric core or of the polymeric sheath. The proportion of the polymeric core or of the polymeric sheath that is attributable to the antimicrobial active is preferably between about 10 and about 5,000 ppm, particularly about 50 and about 2,000 ppm, more preferably about 100 and about 2,000 ppm, particularly about 100 and about 1,000 ppm, based on the overall weight of the polymeric core or of the polymeric sheath.

In a further form, the proportion of the at least one thread that is attributable to the composition is between about 5 and about 60,000 ppm, particularly about 50 and about 24,000 ppm, preferably about 250 and about 10,000 ppm, particularly about 500 and about 5,000 ppm, based on the overall weight of the at least one thread. The proportion of the at least one thread that is attributable to silica is preferably between about 4 and about 57,000 ppm, particularly about 40 and about 22,800 ppm, based on the overall weight of the at least one thread. The proportion of the at least one thread that is attributable to the antimicrobial active is preferably between about 1 and about 3,000 ppm, particularly about 10 and about 1,200 ppm, preferably about 100 and about 1,000 ppm, based on the overall weight, of the at least one thread.

It is further preferable that the at least one thread includes the composition down to a depth (starting from the outside surface of the at least one thread) between about 5 and about 40%, particularly about 5 and about 30%, based on the overall thickness of the at least one thread.

The composition is preferably a powder and more particularly a fine and dusty powder. Depending on the antimicrobial active agent, the composition may have a color or at least a tinge. The presence of silver nanoparticles, for example, may render the composition slightly yellowing to brownish.

The silica in the composition is preferably amorphous, in particular, x-ray amorphous. The silica preferably has a three-dimensional and, more particularly, open structure, particularly in the manner of a Matrix. The three-dimensional structure is preferably porous, in particular, openly porous. The three-dimensional structure may have an interconnecting porosity, i.e., pores/voids which communicate via channels. In general, the at least one antimicrobial active agent is substantially uniformly distributed in the silica, particularly in pores, channels and/or surfaces of the silica. The silica may have particles between about 2 and about 50 nm, particularly about 5 and about 30 nm and preferably about 10 and about 20 nm in diameter. The silica particles can also be present in the form of aggregates and/or agglomerates.

Agglomerates may be organized into superordinate chain-like, in particular beaded chain-like, structures. The chain-like structures may in turn be combined into a superordinate structure featuring voids and connecting channels. The agglomerates themselves may have a diameter between about 50 and about 2000 nm, in particular about 100 and about 1000 nm. Agglomerates are usually rather loosely conjoined structures which can easily be broken apart again under mechanical stress, for example. This makes the composition particularly good for incorporation into a polymer material contemplated for the thread core and/or the sheath. In addition, the composition may also contain mixed agglomerates based on silicon and active-ingredient particles.

The composition preferably has a specific surface area between about 100 and about 400 m²/g. The proportion of the composition that is attributable to the at least one antimicrobial active is preferably between about 1% and about 50% by weight, particularly about 5% and about 50% by weight and more preferably about 5% and about 20% by weight, based on the overall weight of the composition. The proportion of the composition which is attributable to silicon dioxide is preferably between about 80% and about 99% by weight and particularly about 80% and about 95% by weight, based on the overall weight of the composition.

The at least one antimicrobial active preferably comprises antimicrobially active metals, metal alloys and/or metal salts, particularly metal oxides. The at least one antimicrobial active agent is preferably a metal or a metal salt and, more particularly, selected from the group consisting of copper, silver, gold, zinc, titanium, copper oxide, silver oxide, zinc oxide and titanium dioxide. The use of silver and/or silver compounds, for example, silver salts is particularly preferred.

The at least one antimicrobial active agent may further comprise a mixture or a combination of a plurality of antimicrobial active agents. Polyhexamethylenebiguanide and/or chlorhexidine and derivatives thereof are possible for example in addition to the active agents heretofore described.

The at least one antimicrobial active agent may be present in the form of particles. The at least one active agent may be present as nano- to microparticles, particularly in the form of nanoparticles. The particle diameter of the at least one antimicrobial active agent is preferably between about 5 and about 1,000 nm, more preferably about 5 and about 600 nm, particularly about 10 and about 300 nm, even more preferably about 5 and about 20 nm. When the at least one antimicrobial active agent comprises metal particles, particularly metal nanoparticles, the antimicrobial composition may be obtainable/obtained by following a flame spray pyrolysis process.

A first step of this process generally comprises preparing a solution of a metal salt and a preferably volatile silicon compound in an organic solvent. Useful silicon compounds include, in particular, organic silanes, for example, tetraethoxyorthosilane and/or hexamethyldisiloxane. Useful solvents include alcohols, particularly methanol, ethanol, n-propanol, n-butanol, isopropanol, ethanediol, propanediol and also mixtures thereof. In a second step, the solution is then sprayed into a flame having a temperature of about 1500° C. The flame is usually ignited by a gas mixture, for example, of methane and oxygen. Thereafter, the flame generally maintains itself by burning the solution.

With regard to further features and details of the heretofore described composition and also concerning the flame spray pyrolysis process described in the preceding section, reference is made to WO 2006/084411 A1 and WO 2006/084390 A1, the disclosure and content of each of which is incorporated herein by express reference.

The implant is particularly advantageous in offering long-term antimicrobial protection. The antimicrobial protection offered by the implant preferably extends for a period ranging from several months to several years. In the case of a permanent implant, antimicrobial protection can extend to a period of about 10 to about 15 years.

The at least one thread may have a linear density between about 1 and about 3,500 dtex, particularly about 20 and about 1,000 dtex, preferably about 150 and about 250 dtex. The customarily used thread gauges are contemplated, particularly when the at least one thread is configured as a surgical suture, in particular, USP-8/0, USP-7/0, USP-6/0, USP-5/0, USP-4/0, USP-3/0, USP-2/0, USP-0, USP-1, USP-2, USP-3, USP-4, USP-5 and/or USP-6, preferably USP-8/0, USP-7/0, USP-6/0, USP-5/0, USP-4/0, USP-3/0, USP-2/0, USP-0, USP-1 and/or USP-2.

The linear tenacity of the at least one thread is preferably between about 10 and about 100 cN/tex, particularly about 40 and about 80 cN/tex. When the implant is a surgical suture, then the at least one thread preferably has a linear tenacity between about 20 and about 60 cN/tex. When, by contrast, the implant is a textile mesh, then mesh threads can have a linear tenacity between about 30 and about 100 cN/tex, particularly about 40 and about 80 cN/tex. “Linear tenacity” herein is to be understood as meaning the force which is measured in tensile tests and force and distance are recorded. The at least one thread may further have a diameter between about 0.005 and about 1 mm, particularly about 0.05 and about 0.5 mm. The diameter of the thread core may be between about 40 and about 95% of the overall diameter, i.e., the diameter of the at least one thread. The diameter of the polymeric core is preferably between about 8 and about 750 μm, particularly about 12 and about 600 μm.

The at least one thread preferably comprises a monofilament. However, the at least one thread may also be present as a multifilament, in particular, a multifilament yarn in which case individual threads, preferably all individual threads, of the multifilament have a sheath-core structure.

The polymeric core and/or the polymeric sheath may be formed of an absorbable or nonabsorbable polymer material. The polymer material may also be present as a homo-, co-, tri- or tetrapolymer and the like. The material may in particular be present as a block copolymer or block terpolymer.

Useful nonabsorbable polymer materials include but are not limited to polyolefins, polyesters, fluoropolymers, polyamides, polyurethanes and/or copolymers thereof. The nonabsorbable polymer material is preferably selected from at least one material from the group consisting of polyethylene, polypropylene, polytetrafluoroethylene, polyethylene terephthalate, polytetrafluoroethylene, polyvinylidene difluoride and copolymers of vinylidene difluoride and hexafluoropropylene. Polytetrafluoroethylene preferably comprises expanded polytetrafluoroethylene.

Useful absorbable polymer materials include polymers, especially co- or terpolymers, based on hydroxy carboxylic acid units. The absorbable polymer material is preferably at least one polymer from the group consisting of polylactide, polyglycolide, poly(trimethylene carbonate), poly(ε-caprolactone), poly(para-dioxanone), poly(hydroxybutyric acid) and copolymers thereof.

The polymeric core and the polymeric sheath may be formed of the same polymer material.

Alternatively, the polymeric core and the polymeric sheath may be formed of different polymer materials. More particularly, the polymeric core may be formed of a nonabsorbable polymer material and the polymeric sheath of an absorbable polymer material. As mentioned earlier, it is particularly preferable in this case when it is only the polymeric core which includes the composition.

The polymeric core may also be formed of a nonabsorbable polymer material and the polymeric sheath of an absorbable polymer material, in which case the polymeric core includes at least one antimicrobial active having a long-term effect, for example, silver and the polymeric sheath includes at least one antimicrobial active having a short-term effect, for example, polyhexamethylenebiguanide and/or chlorhexidine, particularly in the form of a surficial coating.

The at least one thread may not only include the composition, but also additional additives. These additives may comprise, for example, binding or bonding agents, growth factors, analgesics, anti-inflammatories and/or x-ray contrast media, particularly barium sulphate.

The at least one thread may comprise a plurality of threads, particularly a multiplicity of threads, preferably in the form of a multifilament. These threads are generally present in a form which has been subjected to textile processing. The implant preferably comprises a textile fabric, preferably a woven fabric, a loop-formingly knitted fabric, a loop-drawingly knitted fabric, a braided fabric, a nonwoven scrim, a nonwoven fabric or the like.

The implant may comprise a textile mesh, preferably a loop-formingly knitted textile mesh. The mesh may have openings having an open width between about 0.05 and about 8 mm, in particular, about 0.1 and about 6 mm. The basis weight of the mesh is preferably between about 25 and about 100 g/cm², particularly about 30 and about 80 g/cm². The textile mesh may elongate by about 90 to about 230% when subjected to a maximum tensile force Fₘₐₓ of 10 to 100 N/cm across the knitted direction of the mesh and by about 50 to about 250% when subjected to a maximum tensile load Fₘₐₓ of 10 to 100 N/cm along the knitted direction of the mesh.

The implant preferably comprises a mesh selected from the group consisting of hernia mesh, hernia plug, prolapse mesh and urine incontinence mesh. However, the textile implant may also comprise an endoprosthesis, particularly a stent or vascular prosthesis, or may comprise a textile band.

Preferably, the implant comprises a surgical suture material.

We further provide a tubular medical device having an at least two-layered construction comprising an inner layer surrounding a tubular lumen and an outer layer surrounding the inner layer, wherein the inner layer and/or the outer layer include a composition comprising at least one silica-supported antimicrobial active agent. Preferably it is only the inner layer or only the outer layer which includes the composition. This compartmentization of the composition, particularly of the at least one silica-supported antimicrobial active agent, makes it possible for the advantages mentioned above in connection with the textile implant to be also actualized in relation to the tubular device described in this section.

The tubular medical device may have a three-layered construction. Preferably, the device has an interlayer between the inner and outer layers. The device may thus include an inner layer surrounding a tubular lumen, an interlayer surrounding the inner layer and an outer layer surrounding the interlayer. Preferably, it is only the inner and outer layers which include the composition. As a result, it is only the accessible surfaces (the inner and outer layers) which are rendered antimicrobial. The interlayer, by contrast, is preferably free of the composition, leaving particularly the mechanical properties of the interlayer intact.

The medical device preferably comprises a tubular extrudate. For example, the device may be configured as a catheter, particularly a bladder, dialysis, heart, nephrostomy, peridural, port, tube, urethral or venous catheter. It can similarly be possible for the medical device to comprise a trocar, drainage tube, irrigation tube or the like. With regard to further features and details, particularly in relation to the composition, reference is made to the description heretofore.

We also provide methods of forming the textile implant, wherein a molten thread core polymer and a molten sheathing polymer are coextruded to form sheathed threads, i.e., threads having a sheath-core construction, and the sheathed threads are subsequently processed into a textile implant, wherein the composition is incorporated into the thread core polymer and/or into the sheathing polymer, preferably only the thread core polymer or only the sheathing polymer and more preferably only the sheathing polymer.

In general, the sheathing polymer is coextruded onto the outer circumference of the thread core polymer as long as the thread core polymer is still soft.

The composition may be incorporated into the thread core polymer and/or into the sheathing polymer before the coextrusion step. Preferably, the thread core polymer and/or the sheathing polymer is compounded with the composition. Compounding preferably uses a masterbatch. A masterbatch comprises a concentrate of the composition in the thread core polymer and/or sheathing polymer. To form the masterbatch, the composition is usually mixed with the thread core or sheathing polymer, melted and subsequently extruded. The final shaping of the masterbatch can be effected by pelletizing the extruded material. For instance, the extruded material can be further processed into pellets by strand pelletization or underwater pelletization, for example. The masterbatch can subsequently be remelted and used together with a melt of the thread core polymer and/or a melt of the sheathing polymer for coextrusion to form the thread.

The proportion of the melts used for coextrusion that is attributable to the composition can be between about 50 and about 100,000 ppm, particularly about 50 and about 40,000 ppm, based on the overall weight of the melts. The proportion of the melts that is attributable to the antimicrobial active can be between about 10 and about 5,000 ppm, particularly about 100 and about 2,000 ppm, based on the overall weight of the melts. The melts mentioned in this section preferably comprise the melt of the sheathing polymer.

It is also possible to incorporate the composition into the thread core and/or sheathing polymer even as it is being synthesized.

Various suitable textile techniques are contemplated for processing the coextruded sheath-core threads into a textile implant. These suitable textile techniques are known so that a detailed description is not needed.

We finally also provide methods of forming the tubular medical device, wherein at least two polymer melts are coextruded to form an at least two-layered tubular medical device having an inner layer surrounding a tubular lumen and an outer layer surrounding the inner layer and a composition comprising at least one silica-supported antimicrobial active agent is incorporated into at least one of the polymer melts, preferably only one of the polymer melts. Three polymer melts are generally used to form a three-layered device. It is preferable in this case when the composition is incorporated into two of the polymer melts, preferably into the polymer melts for the inner and outer layers. With regard to further features and details, reference is made as far as possible to the description heretofore.

Further features will be apparent from the subsequent description of representative examples. The individual features can be actualized therein alone or in combination with one another. The representative examples described serve to elucidate and to improve understanding and are not in any way to be understood as limiting.

### Example 1

### Preparation of a Masterbatch of Silver, Silica and Polypropylene

A twin-screw extruder was charged with about 10 kg of medical-grade polypropylene. The polypropylene was melted at a temperature of about 180° C. Then, about 300 g of a composition of amorphous silica and silver nanoparticles were admixed to the molten polypropylene, so that the proportion of the mixture that was attributable to the composition was about 3% by weight. Thereafter, the molten mixture was extruded. This material was pelletized after cooling and used as a masterbatch having a silver content of about 5,000 ppm.

### Example 2

### Preparation of Antimicrobially Active Polyethylene Terephthalate Fibers Having a Sheath-Core Construction

Coextrusion was used to produce polyethylene terephthalate fibers having a sheath-core construction and including in the sheath an antimicrobial composition comprising silicon dioxide as support material and silver as antimicrobial active. Then, the fibers were subjected to antimicrobiological tests corresponding to the requirements of the Japanese industrial standard governing the antibacterial activity and efficacy of textile products (JIS L 1902). To this end, 0.4 g of a fiber sample was wound into dense bundles in 3-plicate. The bundles were sterilized with 70 percent ethanol and then dried. Each filament bundle was subsequently inoculated with 50 μl of a bacterial culture containing about 3*10⁵ colony-forming units of Klebsiella pneumoniae (DSM 789) per cm³, and incubated at 37° C. for 18 hours. Thereafter, still viable bacteria were rinsed off every filament bundle, multiplied and counted. The results found are listed in Table 1 below.

TABLE 1

| | | | | | Average | |
|---|---|---|---|---|---|---|
| | | | | | value of | |
| | | | | | colony- | |
| | | | | | forming | |
| | | | | ppm | units | Reduction |
| # | Type | Core | Sheath | Ag | per cm³ | in [%] |
| 1 | monofilament | — | — | 0 | 3.3 × 10⁵ | — |
| | control (0 h) | | | | | |
| 1 | monofilament | — | — | 0 | 3.8 × 10⁵ | — |
| | (control) | | | | | |
| 2 | monofilament | Ag | Ag | 100 | 1.1 × 10⁵ | 72.35% |
| 3 | monofilament | Ag | Ag | 500 | 1.5 × 10³ | 99.60% |
| 4 | silver in sheath | — | Ag | 500 | 9.9 × 10¹ | 99.97% |
| 5 | silver in core | Ag | — | 500 | 2.9 × 10⁵ | 25.57% |

1. A textile implant comprising at least one thread having a polymeric core and a polymeric sheath which at least partly surrounds the polymeric core, wherein the polymeric core and/or the polymeric sheath include a composition comprising at least one silica-supported antimicrobial active agent.

2. The textile implant according to claim 1, wherein an entire area of the polymeric core is covered by the polymeric sheath.

3. The textile implant according to claim 1, wherein a proportion of the at least one thread which is accounted for by the polymeric sheath is between about 10% and about 60% by volume.

4. The textile implant according to claim 1, wherein only the polymeric sheath includes the composition.

5. The textile implant according to claim 1, wherein the composition is situated in an outermost layer of a sheath constructed in one, two, three or more layers.

6. The textile implant according to claim 1, wherein only the core includes the composition and the core is formed of a nonabsorbable polymer material and the polymeric sheath of an absorbable polymer material.

7. The textile implant according to claim 1, wherein a proportion of the polymeric core or of the polymeric sheath that is attributable to the composition is between about 50 and about 100,000 ppm.

8. The textile implant according to claim 1, wherein a proportion of the polymeric core or of the polymeric sheath that is attributable to the at least one antimicrobial active is between about 10 and about 5,000 ppm.

9. The textile implant according to claim 1, wherein the at least one antimicrobial active is a metal and/or a metal salt selected from the group consisting of copper, silver, gold, zinc, titanium, copper oxide, silver oxide, zinc oxide and titanium dioxide.

10. The textile implant according to claim 1, wherein the at least one antimicrobial active comprises silver and/or silver compounds.

11. The textile implant according to claim 1, wherein the at least one antimicrobial active is present in the form of particles.

12. The textile implant according to claim 1, wherein the at least one antimicrobial active has a particle diameter between about 5 and about 1,000 nm.

13. The textile implant according to claim 1, wherein the at least one thread has a linear tensile strength between about 10 and about 100 cN/tex.

14. The textile implant according to claim 1, wherein the polymeric core and the polymeric sheath are formed of the same polymer material.

15. The textile implant according to claim 1, wherein the polymeric core and the polymeric sheath are formed of different polymer materials.

16. The textile implant according to claim 1, wherein the at least one thread comprises a plurality of threads in the form of a multifilament.

17. The textile implant according to claim 1, wherein the implant comprises a textile fabric comprising a woven fabric, a knitted fabric, a braided fabric or a nonwoven fabric.

18. The textile implant according to claim 1, wherein the implant comprises a textile mesh comprising a hernia mesh, hernia plug, prolapse mesh or urine incontinence mesh.

19. The textile implant according to claim 1, wherein the implant is an endoprosthesis.

20. The textile implant according to claim 1, wherein the implant is a surgical suture material.

21. A tubular medical device having an at least two-layered construction comprising an inner layer surrounding a tubular lumen and an outer layer surrounding the inner layer, wherein the inner layer and/or the outer layer include a composition comprising at least one silica-supported antimicrobial active agent.

22. A method of forming a textile implant comprising coextruding a molten thread core polymer and a molten sheathing polymer to form sheathed threads and subsequently processing the sheathed threads into a textile implant, wherein a composition comprising at least one silica-supported antimicrobial active agent is incorporated into the thread core polymer and/or into the sheathing polymer.

23. The method according to claim 22, wherein the composition is incorporated into the thread core polymer and/or into the sheathing polymer before coextrusion.

24. The method according to claim 22, wherein the thread core polymer and/or the sheathing polymer is compounded with the composition with a masterbatch comprising the composition and the thread core polymer and/or the sheathing polymer.

25. A method of forming a tubular medical device comprising:
coextruding at least two polymer melts to form an at least two-layered tubular medical device having an inner layer surrounding a tubular lumen and an outer layer surrounding the inner layer and incorporating a composition comprising at least one silica-supported antimicrobial active agent into at least one of the polymer melts.
